(19) United States
(12) Patent Application Publication
(10) Pub. No.: US 2023/0271830 A1
(43) Pub. Date: Aug. 31, 2023

(54) METHOD AND APPARATUS FOR PRODUCING HYDROGEN AND POLYMERIZED CARBON COMPOUND

(71) Applicant: APGREEN INC., Ansan-si (KR)

(72) Inventors: Ali Tabatabaie-Raissi, Melbourne, FL (US); Bo Sung KIM, Seoul (KR); Tae Yoon PARK, Seoul (KR)

(21) Appl. No.: 18/059,381

(22) Filed: Nov. 28, 2022

(30) Foreign Application Priority Data
Feb. 3, 2022 (KR) 10-2022-0014314

(51) Int. Cl. C01B 3/38; C01B 32/05

(52) U.S. Cl. CPC C01B 3/382; C01B 32/05; C01B 2203/148; C01B 2203/0261; C01B 2203/0283; C01B 2203/1241

(57) ABSTRACT

Provided are a method and an apparatus for producing hydrogen and a polymerized carbon-rich suboxide compound. The apparatus reacts natural gas by partial oxidation with air to produce a syngas which is a mixture of hydrogen (H₂) and carbon monoxide (CO), separates the syngas by chemical absorption into hydrogen and carbon monoxide, and converts the carbon monoxide in the presence of non-thermal plasma into carbon dioxide (CO₂) and a polymerized carbon suboxide compound residue.

### CROSS-REFERENCE TO RELATED APPLICATION

This application claims the benefit of Korean Patent Application No. 10-2022-0014314 filed Feb. 3, 2022, the content of which is incorporated herein in its entirety.

### BACKGROUND OF THE DISCLOSURE

### Field

The present invention relates to hydrogen production, and more particularly to a method and apparatus for producing hydrogen and carbon compounds with low greenhouse gas emissions.

### Related Art

Due to greenhouse gas emission and global warming problems, the need for the development and diffusion of new and renewable energy that can replace fossil fuels is increasing. Hydrogen is being considered as one of the clean energy sources. Hydrogen exists in a variety of forms, including fossil fuels, biomass and water. In order to use hydrogen as a fuel, it is important to produce it in an economical way as well as in a way that minimizes the impact on the environment.

Hydrogen production methods are divided into production through fossil fuel reforming, a traditional method, and production using renewable methods, biomass and water. Hydrogen production using fossil fuels is possible through thermochemical methods such as wet reforming, autothermal reforming, partial oxidation and gasification.

During the process of producing hydrogen, carbon dioxide is produced. Carbon dioxide is one of the representative greenhouse gases. Therefore, it is necessary to capture carbon dioxide to reduce the emission of carbon dioxide.

### SUMMARY OF THE DISCLOSURE

The present specification provides a method and apparatus for producing hydrogen with low greenhouse gas emissions. The present specification also provides a method and apparatus for converting carbon dioxide generated during hydrogen production into a solidified carbon oxide compounds.

In an aspect, a method for producing hydrogen and a polymerized carbon suboxide is provided. The method includes (a) reacting natural gas by partial oxidation with air to produce a syngas which is a mixture of hydrogen (H₂) and carbon monoxide (CO), (b) separating the syngas by chemical absorption into hydrogen and carbon monoxide, and (c) converting the carbon monoxide in the presence of non-thermal plasma into carbon dioxide (CO₂) and a polymerized carbon suboxide.

In another aspect, an apparatus for producing hydrogen and a polymerized carbon suboxide is provided. The apparatus includes a first unit for reacting natural gas by partial oxidation with air to produce a syngas which is a mixture of hydrogen (H2) and carbon monoxide (CO), a second unit for separating the syngas by chemical absorption into hydrogen and carbon monoxide, and a third unit for converting the carbon monoxide in the presence of non-thermal plasma into carbon dioxide (CO₂) and a polymerized carbon suboxide.

In still another aspect, an apparatus for producing hydrogen and carbon compound is provided. The apparatus includes a partial oxidation (POX) reactor for reacting natural gas by POX with air to produce a syngas which is a mixture of hydrogen (H2) and carbon monoxide (CO), a pressure swing absorption (PSA) unit for separating the syngas by PSA into hydrogen and carbon monoxide, and a plasma reactor for converting the carbon monoxide in the presence of non-thermal plasma into carbon dioxide (CO₂) and a polymerized carbon suboxide.

It reduces the greenhouse gas emissions that can occur during hydrogen production. During hydrogen production, useful solidified carbon compounds can be obtained.

### BRIEF DESCRIPTION OF THE DRAWINGS

FIG. 1 shows the types of plasma and the respective electron temperature and electron number density.

FIG. 2 shows the effect of pressure on the equilibrium temperature of various species in the plasma.

FIG. 3 shows plasma parameters that can be optimized to produce desired excited species.

FIG. 4 shows a schematic diagram of a method for producing hydrogen according to an embodiment of the present invention.

FIG. 5 shows a schematic diagram of a hydrogen production method according to other embodiment of the present invention.

FIG. 6 shows a schematic diagram of a hydrogen production apparatus according to another embodiment of the present invention.

FIG. 7 shows a schematic diagram showing an example of a plasma reactor.

FIG. 8 shows a schematic diagram showing an example of a separator.

FIG. 9 shows a schematic diagram showing another example of a separator.

### DETAILED DESCRIPTION OF THE EMBODIMENTS

The term “plasma” normally refers to an ionized gaseous phase and defined as a quasi-neutral gas of charged and neutral particles that behave, collectively, in a like manner. The “quasi-neutral” designation denotes absence of a net charge within a macroscopic volume within the plasma. At microscale, however, charge imbalances can exist. To be sure, within plasma volumes larger than the so-called “Debye sphere”, approximate charge neutrality must be present - that is, the equality between the number of negatively and positively charged species. For example, the electron density within a hydrogen glow discharge at a pressure of 10 Torr and a field strength of 100 volts per centimeter is about 3 × 10¹⁰ electrons per centimeter cube. The requirement for quasi-neutrality within plasma necessitates that the ion density to be 3 × 10¹⁰ per centimeter cube as well. This represents a degree of ionization of about 10⁻⁷ since the number density of hydrogen in the discharge is about 3 × 10¹⁷ molecules per cubic centimeter.

Unlike neutral gases whose constituents are affected solely by the short-range interactions between gas particles (e.g., intermolecular collisions), far-field portions of a plasma can influence other parts of the plasma. This property is due to the ability of electromagnetic fields radiated from distant locations within the plasma to affect charge carriers within it.

Plasmas is maintained by an energy source (typically, an electric field) of suitable magnitude to allow generation of ionized particles at high concentration. Movement of charged particles in an electric field is governed by the following equation:

$${v}^{o} = \left(\frac{q}{m}\right) ⋅ \left(E + v \times B\right) \qquad \text{[Equation 1]}$$

where v is the velocity of the particle, v^{o} = dv/dt, t is time, q is the charge of the particle, m is the mass of the particle, E is the electric field, and B is the magnetic field. This equation implies that lighter particles will accelerate to much higher degree than the heavier ones in the same environment. For example, an electron of mass mₑ and a proton of mass equal to approximately 1836 mₑ, the electron will reach much higher velocity when exposed to an electric field for a given unit of time than the proton (hydrogen ion). This situation, within a low-pressure plasma, wherein the temperature of the electrons can be much greater than the temperature of the heavier particles gives rise to a non-equilibrium condition within the plasma.

In general, plasma discharge types can be divided into two categories: equilibrium (thermal) plasmas or non-equilibrium plasmas. Equilibrium plasmas include arc discharges and plasma torches while non-equilibrium discharges cover a wide range of plasmas, characterized by large reduced electric fields (electric field E divided by the gas density N) and short time scales (or high frequencies) that prevent the internal energies of gas species (rotational, vibrational, and electronic) to equilibrate before the applied field is changed. The reduced electric field (E/N) describes plasma energy by controlling factors that govern the electron energy, which in turn determines the nature of interactions between the electrons and surrounding gas.

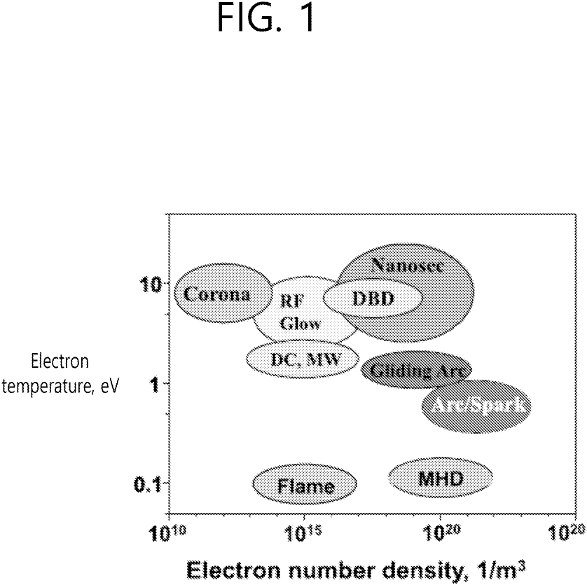

FIG. 1 shows the types of plasmas and their respective electron temperature and electron number density.

The non-equilibrium plasmas may take the form of corona discharges, glow discharges, spark discharges, gliding arc discharges, dielectric barrier discharges (DBD), etc. Each type can be used with different electrode configurations that strongly influence the plasma properties. The primary electrode features include the discharge gap distance, geometry of the electrodes (which determines the localization of the discharge region), and material of construction. Also, the gas parameters that influence the discharge type are pressure, temperature, internal energy configurations of the particular atoms and/or molecules in the gas, and flow rate/speed.

The unique properties of plasma discharges should be considered in the context of both equilibrium and non-equilibrium reaction environments. Such considerations include the role of both elastic and inelastic collisions within a plasma and the sheath physics. Electrons in non-equilibrium plasmas are much more mobile (higher temperature, lower mass) than ions, and consequently achieve high fluxes. Therefore, materials in contact with plasmas will generally charge negatively with respect to the plasma potential. Physics of sheath refers to the structure of the non-neutral layer adjacent to materials in contact with a plasma.

Particles within a plasma (e.g., ions, electrons, radicals, and molecules) interact with each other by means of collisions. When one particle collides with another, it may result in a reaction or excitation of one of the colliding particles, or it may induce an energy or momentum exchange between the two particles. Under non-equilibrium conditions, the electrons within a plasma move much faster than the heavier species. As such, the electrons may be considered to be the incident species in collisions with the heavy species which can be assumed to be at rest.

When an electron is incident upon a rectangular volume within a plasma having unit side area and thickness Δx, the probability that the electron collides with one of the target particles (e.g., hydrogen molecules) depends on the fraction of the area covered by the target particles. In general, the cross section for a given collision is not simply a projected area as in the case of hard-sphere collisions. If the particles interact by other means such as the electrostatic Coulombic force, the collision cross section may be quite different. The collision cross section also depends on the relative velocity of the incident and target particles. A table of some possible interaction potentials and their corresponding cross sections is given below:

TABLE 1

| | | |
|---|---|---|
| Interaction Force | Potential, U(r) | Cross Section, σ(v) |
| Coulombic | 1/r | 1/v⁴ |
| Dipole | 1/r | 1/v² |
| Induced Dipole | 1/r | 1/v |
| Hard Sphere | 1/rⁱ, i → ∞ | const. |

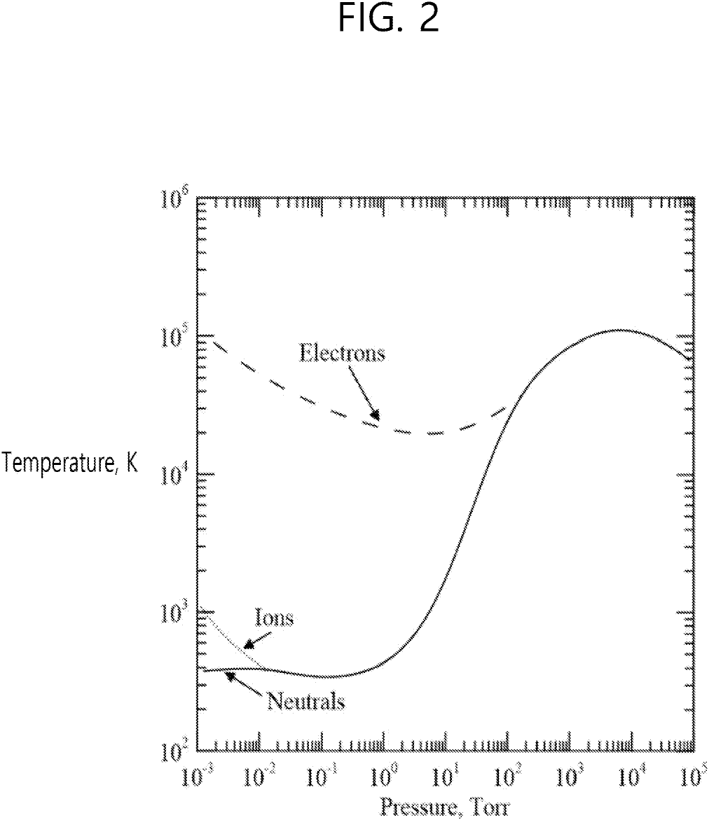

The following equation denotes the dependence of the equilibration between the temperature of the electron Tₑ and heavy particles on the reduced electric field E/nₕ

$$\frac{\text{ΔΤ}}{{T}_{e}} \sim {\left(\frac{E}{{n}_{h}}\right)}^{2} {}_{i v r σ} \qquad \text{[Equation 2]}$$

where ΔT represents the difference in temperature between the electrons and the heavy particles. At low pressures (low number densities nₕ), ΔT is large such that the electrons are much hotter than the heavy particles. In contrast, at high pressures (high concentrations nₕ), ΔT is small such that electrons and heavy species are in thermal equilibrium. Thus, this equation describes the general behavior shown in FIG. 2.

FIG. 2 shows an effect of pressure on the equilibrium temperature of various species in the plasma. This presents the physical basis of the non-equilibrium behavior present in low pressure plasmas; i.e., how the electrons within a plasma discharge can be at such a high temperature relative to the temperature of the heavy particles.

Within a non-equilibrium plasma, electrons are excited by the electric field to a greater degree than heavy ions. The energy exchange between electrons and heavy particles is relatively inefficient due to the large difference in their masses, the electrons within a nonequilibrium plasma possess a higher temperature than do the heavy particles. However, the heavy particles (i.e., ions, atoms, molecules, etc.) and electrons approach thermal equilibrium at increased pressures and decreased electric field strengths. The higher temperatures attained by the electrons within a non-equilibrium plasma endows these plasma discharges with novel properties. For example, the high-temperature electrons within a plasma can generate a high concentration of excited species such as atomic radicals or vibrationally excited molecules (via inelastic collisions), resulting in a high degree of chemical activity within the plasma.

The fact that the heavy particles are at much lower temperature, thermal losses to the environment are negligible. This is contrasted with the situation that exists within the thermal (equilibrium) plasmas, where high chemical activity is achieved, but at the expense of high thermal losses to the environment. As such, a thermal plasma often requires extensive cooling to allow and rapid quenching of the reaction products to prevent back-reactions. The non-equilibrium plasmas do not experience these limitations to the same extent - providing both the high reactivity and high thermal efficiency at the same time.

Finally, among many unusual properties of non-equilibrium plasmas is the effect of the non-equilibrium environment on the reaction pathways and corresponding reaction products produced. For example, carbon suboxide polymer can form in a non-equilibrium plasma during partial oxidation (POX) of methane. Such species have not been observed to be present in the reaction products of methane POX within the thermal (equilibrium) plasmas.

Excited species within a plasma-e.g., ions, radicals, or vibrationally/rotationally excited molecules—are produced when electrons collide inelastically with lower-energy heavy species (i.e., ground state or metastable atoms, or molecules). As an example, the collision of an electron with a hydrogen molecule can produce two hydrogen atoms via the reaction:

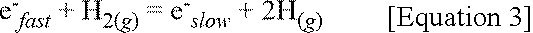

where, the kinetic energy of the fast electron induces dissociation of the hydrogen molecule into the higher-energy state of two hydrogen atoms. This reaction can be visualized as a collision between the incident electron and the target hydrogen molecule. In general, the cross section for inelastic collisions like this depends on the relative velocity of the incident electron and the target molecule. This relative velocity, in turn, depends on the parameters of the plasma discharge-notably, the reduced electric field E/nh. The choice of plasma operating parameters impacts the energy efficiency of a particular process significantly: moving from 20 to 100 V Torr-1 cm-1 changes the proportion of energy transferred from electrons to heavy species through elastic collisions by a factor of more than six.

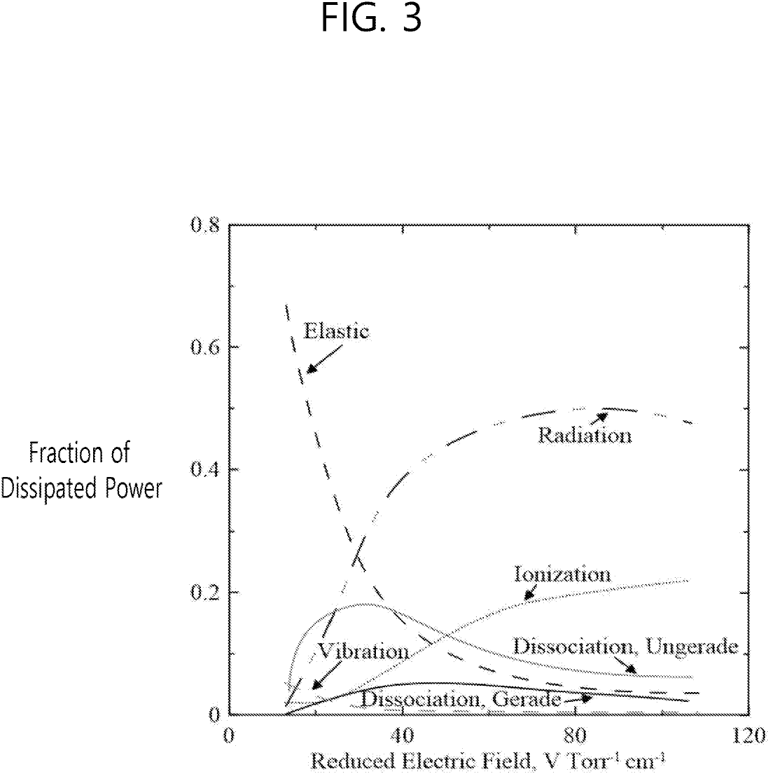

FIG. 3 shows the plasma parameters that can be optimized to produce desired excited species. For example, in order to maximize the efficiency of dissociation that would occur within a hydrogen plasma (to produce atomic hydrogen), it would be advantageous to operate in the range of 30 to 50 V Torr-1 cm-1, given the contributions of the two contributing dissociation mechanisms.

Ionization is a specific case of an inelastic collision, in which an incident electron knocks free another electron from the target particle. The electrically accelerated electrons produce more electrons by ionizing neutral species. These daughter electrons are themselves accelerated until they can induce further ionization, and so on. This accelerating process (termed an “avalanche breakdown” (von Engel 1965)) results in the development of the appreciable degree of ionization that defines a plasma.

As described before, electrons have a higher average speed than do ions. Therefore, a given (neutral) surface will experience a higher flux of electrons than that of ions. This results in the development of a negative electrical potential on ungrounded solids placed within a plasma since there is a net flux of negative electric charge to solid. As this electrical potential becomes larger in magnitude, it acts to repel lower-energy electrons and attract ions, thereby resulting in a smaller magnitude negative current to the solid, thereby making the electrical potential of the solid closer to zero. Ultimately, this process reaches equilibrium and a steady-state electrical potential is established. For an ungrounded solid, this potential is known as the floating potential; for a typical plasma, the floating potential may be lower than the potential of the bulk plasma by as much as 10 to 30 volts (Ruzic, Weed, and Society 1994). The floating potential transitions to the bulk plasma potential across a sheath, typically several Debye lengths in thickness.

A grounded solid or a solid biased at a potential different than the floating potential will attract a net current. Quantifying the magnitude of this collected current as a function of the biasing voltage using a device called a Langmuir probe allows one to determine a number of plasma parameters, including the electron temperature Te and the concentration of ionized species within the plasma. Negative potentials may also be applied to solids with the intent of accelerating ions towards the surface. The impact of these highly accelerated ions on the solid surface is chemical reactions that occur on the surface of the solid.

Atmospheric-pressure low-temperature plasma (APLTP) operates in a non-equilibrium state under most operating conditions. One of the main features of APLTPs is that the characteristic electron energy ranges from a few eV to 10 eV, while the heavy-particle temperature varies from around the room temperature to a level which is comparable to but usually lower than the electron temperature. This is due tophysical the significant mass difference between electrons and heavy particles (e.g., molecules, atoms and their ions). There are three types of non-equilibria APLTP, namely, (i) Non-electrical-equilibrium (NEQ): if a conductive or non-conductive object is inserted into the plasma region, a sheath deviating from the quasi-charge neutrality condition arises between the object surface and the plasma region, and most of the total electric potential drop occurs at this NEQ region. (ii) Non-local-thermodynamic-equilibrium (NLTE): the low mass ratio of electrons to heavy particles in plasmas (e.g., 10-5 for argon) leads to an insufficient elastic energy exchange between electrons and heavy particles. (iii) Non-local-chemical-equilibrium (NLCE): since the mean electron temperature is around several electron volts (eV), which is lower than the inelastic collision energy thresholds of tens of eV, the excitation and ionization rates decrease significantly particularly when interacting with cold gas.

Carbon suboxide(C₃O₂) is an oxide of carbon with a chemical formula of C₃O₂ which has a special structure characterized by a sequence of double bonds O═C═C═C═O and therefore is considered as a cumulene. Contrary to other common alkanes and alkenes, cumulenes have a tendency of being rigid as compared to alkynes. The unique structure and rigidity of carbon suboxide as a cumulene makes it appealing for use in molecular nanotechnology. Their rigidity arises from the fact that the intramural carbon atoms carry two double bonds. The sp-hybridization of these carbon atoms therefore results in the formation of two π bonds, which are perpendicular to each other. Owing to this bonding process, the linear geometry of the carbon chain is reinforced. Simple electric discharges from carbon monoxide may lead to the generation of carbon suboxide.

Carbon suboxide, also known as Tricarbon dioxide, contains carbon in the formal oxidation state of +4/3. Because this is lower that its oxidation state in either CO or CO₂, the oxide is called carbon suboxide. The molecule is linear and has the structure.

The molecule contains three carbon atoms bonded together, so this suggests a method for its preparation by dehydrating an organic acid containing three carbon atoms. Because C₃O₂ is formally the anhydride of malonic acid, HOOC—CH₂—COOH, one way to prepare C₃O₂ is by the dehydration of that acid using a strong dehydrating agent such as P₄O₁₀ as shown below.

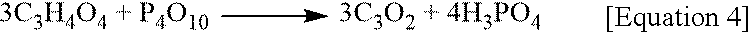

The reaction of C₃O₂ with water produces malonic acid. Although it is stable at low temperatures, carbon suboxide will readily burn, and it polymerizes when heated.

When carbon is burned with excess air or oxygen, CO₂ results; but if the supply of oxygen is limited, highly toxic CO is formed. Other, CO or CO₂ which has higher oxides of carbon can be formed by indirect methods; for example, carbon suboxide results from the dehydration of malonic acid, a three-carbon dicarboxylic acid. The Lewis structures of these three oxides indicate the presence of multiple bonds:

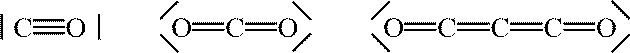

At room temperature, carbon monoxide is a colorless, odorless, and tasteless gas; its boiling point is -192° C., and its melting point is -205° C. The extreme toxicity of CO arises from its capacity to bind to the iron ion in hemoglobin molecules, thus reducing the capacity of hemoglobin to bind and carry O₂.

Carbon monoxide has a number of important industrial uses as a fuel,

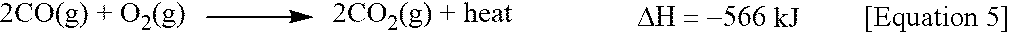

as a reducing agent in metallurgy,

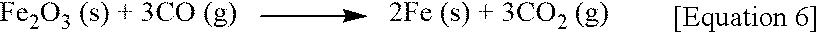

and as a reactant in the preparation of important organic compounds:

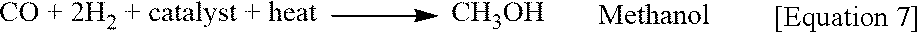

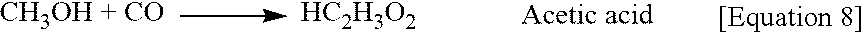

Carbon dioxide is a colorless, odorless gas. When cooled at atmospheric pressure, it solidifies to form dry ice. This solid sublimes at atmospheric pressure and a temperature of -78° C. All three physical states of CO₂ are useful: more than half of the solid CO₂ produced annually is used as a refrigerant, liquid CO₂ is used as an aerosol propellant, and gaseous CO₂ is used primarily to carbonate beverages.

A significant amount of CO₂ is used to manufacture urea, which ranks thirteenth by weight among the top 50 chemicals produced in the United States:

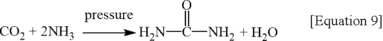

It is known that the formation of aliphatic hydrocarbons from iron catalyzed CO₂ hydrogenation reactions proceeds as follows. First, there is conversion of CO₂ to CO via the reverse water-gas shift reaction (RWGS)

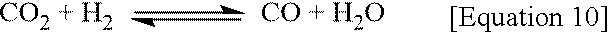

Then, hydrocarbon chains are built up through the Fischer-Tropsch reaction.

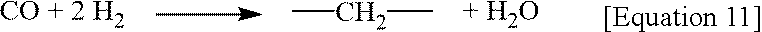

However, if Fe/Fe₃O₄ nano-catalyst is present, a cluster of reactions leads to formation of aromatic products. The reaction between two CO molecules results in carbon laydown on the surface of the catalyst and the formation of CO₂ via Boudouard reaction:

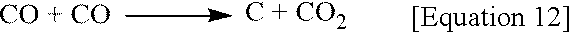

Under special reaction conditions, two CO molecules react stepwise with the freshly deposited carbon on the catalyst to yield carbon suboxide (C₃O₂)

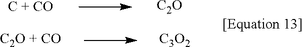

The carbon suboxide (C₃O₂) is metastable and undergoes rapid polymerization at temperatures above 400° C. Under certain reaction environments, C₃O₂ is reduced by H₂ to H₂C₃O₂ instead of forming a polymer.

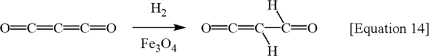

Dicarbon monoxide (C₂O) is a molecule that contains two carbon atoms and one oxygen atom. It is a linear molecule that, because of its simplicity, is of interest in a variety of areas. It is, however, so extremely reactive that it is not normally encountered in the environment. Dicarbon monoxide is a product of the photolysis of carbon suboxide.

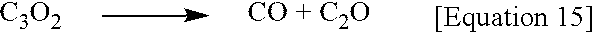

Called ketenylidene in organometallic chemistry, it is a ligand observed in metal carbonyl clusters, e.g. [OC₂Co₃(CO)₉]⁺. Ketenylidenes are proposed as intermediates in the chain growth mechanism of the Fischer-Tropsch Process, which converts carbon monoxide and hydrogen to hydrocarbon fuels.

The present disclosure relates to methods for converting natural gas (including sour gas/sub-quality natural gas) into to high purity hydrogen gas without the release of hazardous and greenhouse gases into the atmosphere. More specifically, the present disclosure relates to methods for the preferential production of hydrogen as the only product gas and condensable polymers that can be readily sequestered greenhouse gas such as carbon, etc.

When natural gas, as well as renewable methane and hydrocarbon sources such as landfill gas, digester gas, bio-syngas, are reacted with air and/or oxygen gas to produce energy, various carbon- and often sulfur-containing products are generated. Among these products, there exist species such as carbon dioxide (CO₂), carbon monoxide (CO), sulfur dioxide (SO₂), hydrogen sulfide (H₂S), carbon disulfide (CS₂), carbon subsulfide (C₃S₂) and carbonyl sulfide (COS), to name just few.

Carbon monoxide is produced, for example, when graphite (one of the naturally occurring forms of elemental carbon) is heated or burned in the presence of a limited amount of oxygen. The reaction of steam with red-hot coke also produces carbon monoxide along with hydrogen gas (H₂). Coke is the impure carbon residue resulting from the burning of coal. This mixture of CO and H₂ is called water gas or syngas and is used as an industrial fuel or feedstock for organic synthesis. In the laboratory, carbon monoxide is prepared by heating formic acid, HCOOH, or oxalic acid, H₂C₂O₄, with concentrated sulfuric acid, H₂SO₄. The sulfuric acid removes and absorbs water (H₂O) from the formic or oxalic acid. Because carbon monoxide burns readily in oxygen to produce CO₂, as exemplified in the following reaction,

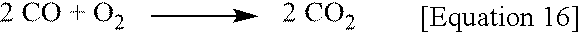

Carbon monoxide is useful as a gaseous fuel. Carbon monoxide is also useful as a metallurgical reducing agent because at high temperatures it reduces many metal oxides to the corresponding elemental metal. For example, copper (II) oxide, CuO, and iron (III) oxide, Fe₂O₃, can be reduced to the corresponding metals by carbon monoxide.

Carbon monoxide is an extremely dangerous poison as it is an odorless and tasteless gas, giving no warning of its presence. Carbon monoxide has an affinity for hemoglobin that is two hundred times greater than that of oxygen. Thus, carbon monoxide readily replaces oxygen and binds to the hemoglobin in blood to form carboxyhemoglobin that is so stable that it cannot be broken down by body processes. The ability of red cells to carry oxygen is destroyed by exposure to carbon monoxide, and suffocation may occur.

Carbon dioxide is produced when any form of carbon or almost any carbon compound is burned in the presence of an excess of oxygen. The Earth’s atmosphere contains approximately 0.04 percent carbon dioxide by volume and serves as a huge reservoir of CO₂. The carbon dioxide content of the atmosphere has been increasing primarily due to combustion of fossil fuels. A so-called greenhouse effect results from increased carbon dioxide and water vapor in the atmosphere. These gases allow visible light from the sun to penetrate to the Earth’s surface, where it is absorbed and reradiated as infrared radiation. This longer-wavelength radiation is absorbed by the CO₂ and water and cannot escape back into space. The resulting increased heat in the atmosphere could cause the Earth’s average temperature to increase 2°-3° C. This change would have a catastrophic impact on the environment, affecting climate, ocean levels, and agriculture.

Carbon suboxide, C₃O₂, is a foul-smelling, lachrymatory gas that can be produced by the dehydration of malonic acid, CH₂(COOH)₂, with P₄O₁₀ in a vacuum at 140° to 150° C. Carbon suboxide is a linear, symmetrical molecule whose structure can be represented as O═C═C═C═O. At 25° C., the compound is unstable and polymerizes to highly-colored solid products, but it is a stable molecule at -78° C. Polymerized carbon suboxide (PCS) is generally considered to be a substance with variable composition as the carbon to oxygen ratio in the PCS is not constant.

Under the influence of ultraviolet light, C₃O₂ decomposes to the very reactive molecule ketene, C₂O. Since carbon suboxide is the acid anhydride of malonic acid, it reacts slowly with water to produce malonic acid.

A method to use only the hydrogen component from all hydrocarbon fuels and keep carbon as a solid waste or raw material was proposed. The major drawback of this method is that only a small portion of the available hydrocarbon chemical energy is actually utilized. For example, in the best scenario for this method, only about a half of the available energy from the reactions in equations (17) and (18) is actually released and utilized as compared to the energy produced from a complete methane oxidation, shown in equation (19).

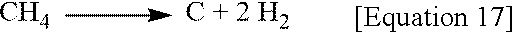

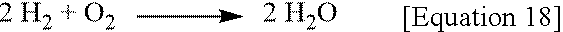

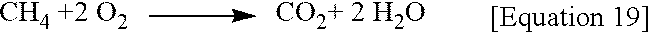

Suboxide polymers have chemically and thermodynamically stable structures similar to humic acids, the organic component of most fertile soils, and can be used as a soil conditioner. Use of biomass as fuel is a commonly accepted way to reduce net carbon emissions, however, recent sources indicate that agricultural land use may release carbon stored in soil, effectively counteracting advantages of biomass-derived fuel. Recycling of suboxide polymer to agricultural soils can mitigate carbon losses in soil as well as capture the economic advantage of carbon sequestration (currently over $80 per ton of carbon).

Due to the potential environmental impact of carbon dioxide emissions, there remains a need to reduce the carbon dioxide emissions while increasing the use of energy released from hydrocarbon fuels. Production of different carbon products in the form of a solid would reduce carbon oxide production thus reducing atmospheric pollution as well as slowing if not stopping the effects of greenhouse gas on the earth.

The application of non-thermal plasma for fuel conversion and H₂ production is especially effective because plasma is used not as a source of energy but as a non-equilibrium generator of radicals and charged and excited particles. The plasma-generated active species just stimulate this process and contribute only a very small fraction (on the level of only a couple of percent) of the total process energy.

While high-energy-efficiency plasma catalysis of the partial oxidation process is mostly relevant to the non-thermal discharges, industrial applications of the technology usually require relatively high productivity of syngas and, therefore, a relatively high power of the applied discharges. The gliding arc discharges are well suited for this due to their ability to remain strongly non-equilibrium and mostly non-thermal even at relatively high power levels. In particular, with regard to the yield and energy efficiency, the CH₄ partial oxidation process for syngas production has been shown to be effective by use of the non-equilibrium gliding arc discharge stabilized at atmospheric-pressure in the reverse vortex flow. In this regime, the flow pattern provides high gas velocities necessary for motion of the non-equilibrium gliding arc and effective heat and mass exchange at the central zone of the plasma.

A continuous transition from non-reacting to fully reacted CH₄/O₂/diluents mixtures is possible by controlling the plasma parameters and mixture composition. This continuous transition is caused by electron collision reactions producing a mixture of electronically excited species, ions, and atoms, all of which rapidly quench forming mostly O and H atoms and OH radicals. These radicals react with the CH₄ and intermediates, and, depending on the temperature, can cause ignition of the mixture or partial oxidation of the fuel (CH₄). While the power and the magnitude of the reduced electric field, E/N, of the plasma affects the overall conversion, the product composition is largely controlled by the chemical kinetics of oxidation reactions at low temperature (300-700 K).

The formation of a weakly ionized and radiating plasma in front of a weak shock wave propagating in inert gas containing a mixture of reacting molecules is another method for achieving non-equilibrium conditions. Introduction of a H₂S-rich natural gas (sour gas) in such an environment will cause immediate dissociation of H₂S/CH₄ and the formation of a supersaturated vapor of sulfur and carbon atoms, which is followed by the rapid formation of sulfur suboxide and C₃O₂ clusters. The intense energy release in the process leads to their non-equilibrium excitation and ionization.

Previous work on the ultraviolet light, electrical discharges and microwave radiolysis of CO has established that CO decomposes to produce CO₂ and a carbonaceous solid. The mean empirical composition of solid formed at 20° C. is represented by a ratio of x/y = 1.45±0.07 in the formula (CₓO_{y})ₙ; to simplify notation this solid is subsequently referred to as (C₃O₂). Furthermore, evidence exists for a buildup of C₃O₂ from C to C₂O to C₃O₂. This mechanism has been shown to prevail in the photochemistry of CO. In addition, a reaction between a C atom and C₂O has been suggested to explain the excitation of the C₂ high-pressure bands observed during radiation of helium + CO mixtures.

From prior work on the photolysis of C₃O₂, it appears that a species is primarily produced which reacts with a variety of hydrocarbon gases such as olefins where a C atom is inserted into the double bonds. It seems certain that this species is the radical C₂O. Low-pressure work in fast flow systems has shown that C₃O₂ reacts with O atoms in a fast reaction, yielding CO and CO₂ as products. In addition, a chemiluminescence of CO excited with as high as ~9 eV is observed. It has been postulated that this high energy originates from the reaction of C₂O with O atoms.

In all the above examples, the radical C₂O plays an important role, either as a building block for C₃O₂ or as a reactive intermediate from the decomposition of C₃O₂, either photolytic or chemical.

Carbon suboxide can be formed by means of the action of the electric discharge on CO. Consider the following reaction for the suboxide formation:

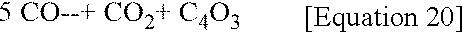

When the suboxide was heated in an atmosphere of nitrogen another brown colored oxide was formed according to the following equation:

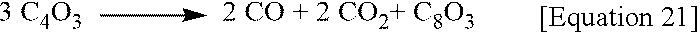

CO ca be decomposed in the iozonizer as the following decomposition reaction:

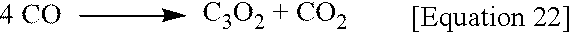

Alternatively, CO can be decomposed by using an alternating electric field of 250 c/s (cycles per second) and 20,000 V/cm as shown in the following equation:

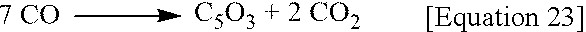

CO in the glow discharge can give CO₂ and carbon suboxide by using both aluminum and iron electrodes. CO can be decomposed by using high speed electrons produced by a cathode ray tube as in the following equation:

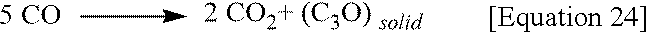

When water vapor was present no deposit was formed. CO can be decomposed to carbon and oxygen using radon emanation. The following reaction shows the decomposition of CO by α particles:

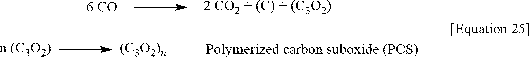

The deposit obtained as a yellow-brown solid is insoluble in water, acid, or alkali but disappears slowly in concentrated nitric acid or concentrated potassium hydroxide. A stoichiometric mixture of CO and O₂ gives only CO₂ and an excess of either does not affect the reaction speed.

In an embodiment of the present disclosure, a method for producing hydrogen with low greenhouse gas emission is provided. In another embodiment of the present disclosure, a method for producing a polymerized carbon containing compound by processing carbon oxides.

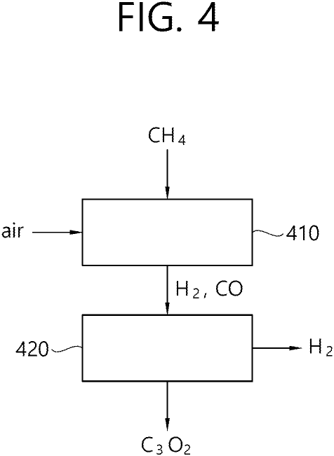

FIG. 4 shows a schematic diagram of a method for producing hydrogen according to an embodiment of the present invention.

Methane-containing gas (e.g., natural gas) is input to a first unit 410 as an energy source. Natural gas is an example of energy sources. The energy sources may include a hydrocarbon gas. Hydrocarbon gas may include natural gas, liquefied petroleum gas (LPG), methane, propane, biogas, and pyro-gas (producer gas). Hereinafter, methane, which is a main component of natural gas, will be described as an example of energy sources.

Air is introduced into the first unit 410. In the first unit 410, natural gas reacts with air by partial oxidation (POX) as shown in the following equation, and syngas is discharged.

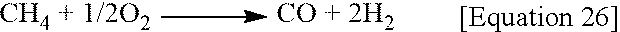

Syngas is a mixture of CO and H₂. Syngas may further contain small amounts of CO₂. The first unit 410 may be a POX reactor for performing POX. A catalyst (metal catalyst, plasma catalyst, or a combination thereof) may be used for POX. Furthermore, partial oxidation may be carried out in a thermos-neutral or auto-thermal manner during which no input energy into the reactor is necessary.

The syngas is input to a second unit 420. Syngas is separated into H₂ and CO, and H₂ is released. Chemical absorption may be performed for separation of the syngas. In one embodiment of present invention, a metal hydride bed is provided for hydrogen capture and removal. Examples of suitable metal hydrides that can be utilized to conduct hydrogen capture include but not limited to iron-titanium (FeTi) and lanthanum panta nickel (LaNi5). The separated CO is converted into solidified carbon suboxide containing compound and carbon dioxide as shown in the following equation in the presence of plasma. The plasma may include non-thermal plasma (NTP).

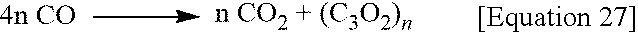

Polymerized carbon compounds can be obtained directly from CO obtained from natural gas. The production of gaseous carbon oxides is reduced by the preferential formation of polymerized carbon suboxide while hydrogen is released from the hydrocarbon source. In particular, solidified carbon suboxide can be used as a fertilizer (e.g., a soil improver), so there is no need for separate storage or treatment.

The first unit 410 and the second unit 420 may be designed as independent reactors or an independent compartment, or may be designed as a single reactor.

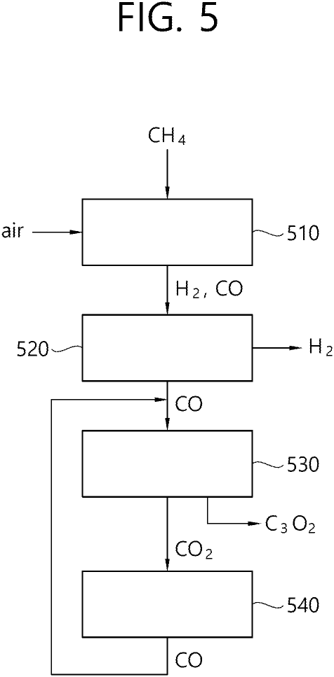

FIG. 5 shows a schematic diagram of a hydrogen production method according to other embodiment of the present invention.

In a first unit 510, natural gas reacts with air by POX, and is discharged as syngas. The first unit 510 may be a POX reactor. A catalyst (metal catalyst, plasma catalyst, or a combination thereof) may be used for POX.

In a second unit 520, the syngas is separated into H₂ and CO. The second unit may perform a chemisorption process such as pressure swing adsorption (PSA) or a metal hydride bed.

In a third unit 530, CO is converted into polymerized carbon suboxide and a small amount of carbon dioxide in the presence of NTP. The third unit 530 may be an NTP reactor such as a gliding arc discharge (GAD) or a dielectric barrier discharge (DBD) system.

CO₂ emitted from the third unit 530 is converted into CO together with hydrogen in a fourth unit 540 as shown in the following equation. Hydrogen may be obtained from the output of the second unit 520. The fourth unit 540 may be a reactor for performing reverse water-gas shift reaction (RWGS).

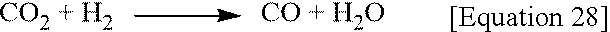

The obtained CO is fed back to the third unit 530 to react as in the equation 27.

The first unit 510 to the fourth unit 540 may be designed as at least one reactor or at least one compartment.

CO₂ emitted from the third unit 530 is input to the fourth unit 540. CO discharged from the fourth unit 540 is inputted back to the third unit 530. By repeating this process, most of the carbon gas (e.g., CO, CO₂) can be converted into a solid carbon compound. Emissions of CO and CO₂ generated in the process of hydrogen production can be almost eliminated. In addition, the solid material obtained as a by-product can be easily collected.

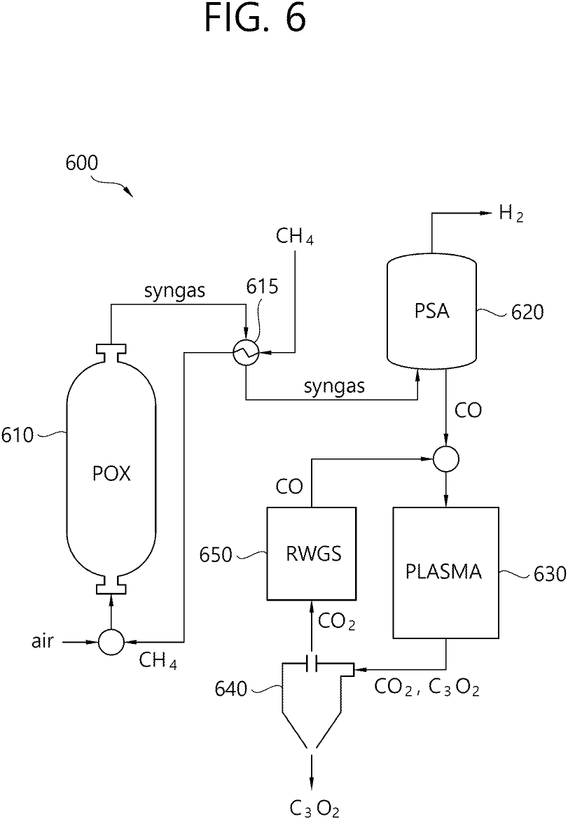

FIG. 6 shows a schematic diagram of a hydrogen production apparatus according to another embodiment of the present invention.

A hydrogen production apparatus 600 includes a POX reactor 610, a PSA unit 620, a plasma reactor 630, a separator 640, and a RWGS reactor 650.

Natural gas (e.g., CH₄) is guided to the POX reactor 610 through a heat exchanger 615. Air is also input to the POX reactor 610 separately from natural gas. The POX reactor 610 performs partial oxidation. Partial oxidation can occur without a catalyst. The partial oxidation may occur in the presence of at least one of a metal catalyst, a plasma catalyst, and or a combination thereof. The metal catalyst may include a granular catalyst such as nickel oxide supported on ferric oxide.

The POX reactor 610 may operate intermittently. In the first cycle, only natural gas enters and reacts with the catalyst to generate H₂ and CO discharged from the reactor 610. The catalyst may be a re-generable redox catalyst. In the second cycle, the flow of CH₄ is captured and air is introduced into the reactor 610 to re-oxidize the catalyst to its original state and burn and remove the remaining residual coke to regenerate the catalyst.

The partial oxidation in the POX reactor 610 may occur at a temperature within the range of 300° C. to 700° C. (preferably 400° C. to 600° C.). Energy consumption can be reduced by performing partial oxidation at a relatively low temperature near 500° C.

The plasma reactor 630 to be described later may be coupled with the POX reactor 610. A synergistic effect exists between the plasmatron and the redox catalyst, allowing partial oxidation of CH₄ at significantly lower reaction temperatures. One reason to use POX instead of Steam Methane Reforming (SMR) is that it can operate in an endothermic or exothermic (or autothermal for that matter) regime and, if a suitable catalyst (with a plasma) is used, it can work very efficiently in low temperatures (below 600° C.).

The POX reactor 610 may be charged with nickel supported on granular iron oxide (Fe₂O₃/NiO) or Ni and/or noble metal catalyst supported with any number of transition metal oxides. The POX reactor 610 may be operated in a chemical looping regime. The benefit of that approach is to mitigate the carbon laydown without excessive introduction of O₂ into the reactor 610 and/or elevated temperatures that otherwise would be necessary. Operating the reactor 610 in a chemical looping regime has the advantage of preventing the dilution of the output gas (e.g., syngas) by di-nitrogen N₂. In other words, the syngas leaving the POX reactor 610 contains only CO, H₂ and some amounts of CO₂.

The hot syngas exiting the POX reactor 610 may exchange heat with natural gas and/or air entering through a heat exchanger 615 before entering the PSA unit 620.

The PSA unit 620 separates hydrogen and CO components of the syngas through the PSA. High purity hydrogen is recovered and stored. Most of the gas except hydrogen discharged from the PSA unit 620 is CO.

The plasma reactor 630 converts CO to polymerized carbon suboxide in the presence of NTP. The plasma reactor 630 converts CO to polymerized carbon suboxide by means of NTP assisted reformation. The CO-rich gas may be irradiated with hot electrons while passing through the plasma reactor 630 to be converted into a mixture of carbon black and carbon suboxide. In addition, some CO₂ may also be produced. The plasma reactor 630 may be a gliding arc discharge (GAD) system or a dielectric barrier discharge (DBD) system.

The separator 640 separates CO₂ and polymerized carbon compounds from the gas and mixture discharged from the plasma reactor 630. The separator 640 may be a cyclone separator.

The CO₂ gas discharged from the separator 640 is reduced together with hydrogen in the RWGS reactor 650 to form CO that is recycled back to the plasma reactor 630.

In the above-described embodiment, in the plasma reactor 630, syngas (e.g., CO, CO₂, etc.) may be converted into a polymerized carbon compound in the presence of NTP. In the plasma reactor 630, hydrocarbons (e.g., CO, CO₂, etc.) may be converted into a polymerized carbon compound by means of NTP assisted reformation. It can also be applied to carbon capture without hydrogen production.

The emission of CO and CO₂ obtained as a by-product of the reaction to obtain hydrogen gas can be almost eliminated.

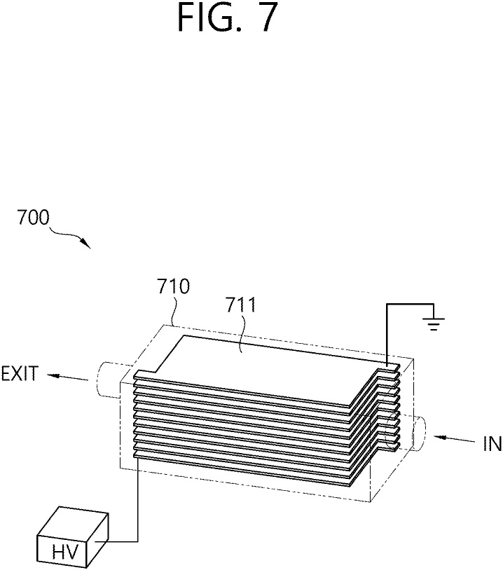

FIG. 7 shows a schematic diagram showing an example of a plasma reactor. A plasma reactor 700 uses DBD plasma. The plasma reactor 700 includes at least one DBD unit 710, and each DBD unit 710 includes a plurality of DBD cells 711.

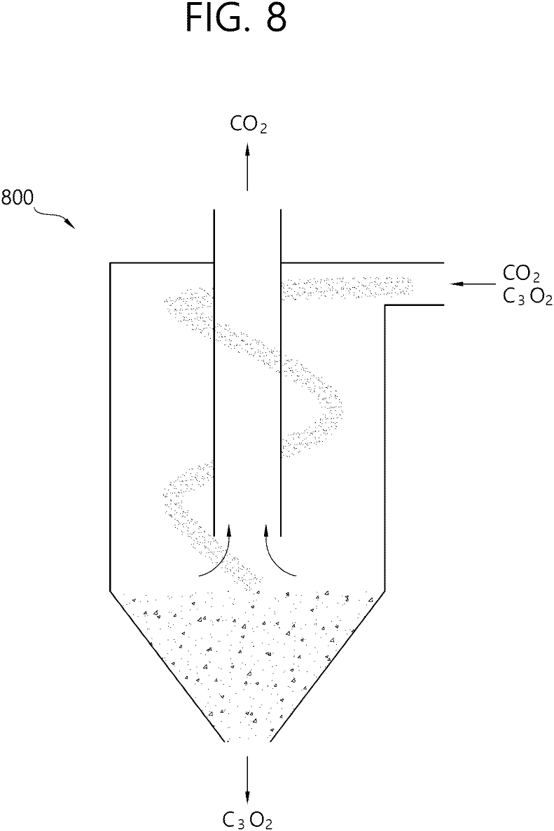

FIG. 8 shows a schematic diagram showing an example of a separator. A separator 800 is a cyclone separator. A mixture of CO₂ gas and polymerized carbon compound is introduced into the separator 800. The solid is discharged to the lower portion of the separator 800 through a vortex configuration. The CO₂ gas is discharged to the top of the separator 800.

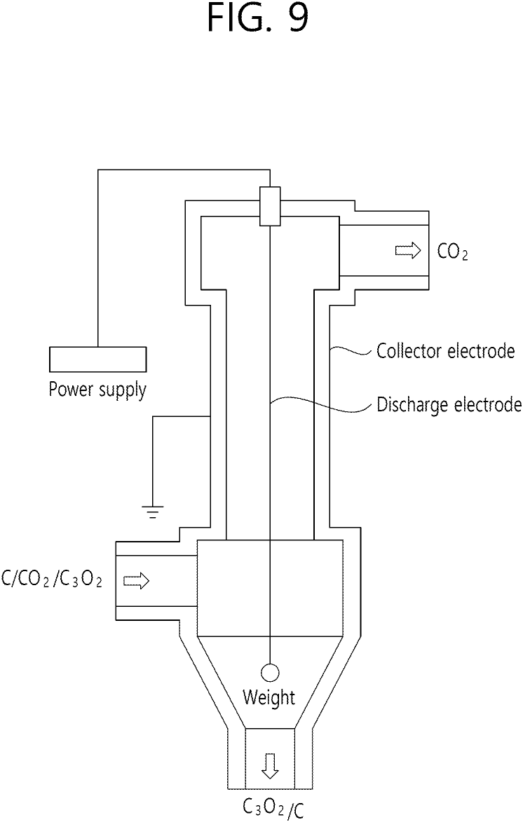

FIG. 9 shows a schematic diagram showing another example of a separator. A separator is an electrostatic separator. A mixture of CO₂ gas and polymerized carbon compound is introduced into the separator. The solid is discharged to the bottom of the separator.

The basic principle of an electrostatic precipitator (ESP) is to give particles an electrostatic charge and then place them in an electrostatic field that forces them to a adhere to a collecting plate. A gas stream containing suspended particulates passes between two electrodes electrically insulated from each other, and between them a large electric potential exists. The high-voltage electrode is a wire. The other electrode could be a plate or a surface of only slight curvature. The high voltage on the wire ionizes the gas and aerosol particles. A corona is formed by the ionization of particles in the gas, which then attracted to the large surface area collecting electrode. Particles are then flow down by pull of gravity and collected at the bottom in a bin. The ESP uses electric forces to separate gas borne suspended particles from gases by following steps that involve 1) a corona-charging field that induces an electrical charge on the particles, and 2) a high-voltage field that attracts the charged particles to the collecting electrodes/plates.

FIG. 9 shows one “gas passage” of a horizontal electro-filter. Many of such lanes are arranged in parallel in one casing so that the actual gas volume finds a sufficient section to flow through. In order to obtain an effective corona discharge, the discharge electrode is supplied with 15 to 80 kV negative DC current. The corona-discharge charges the particles in the gas stream.

The DBD-POX reactor according to the present embodiment can operate in fuel (CH₄) rich regime ([O]ᵢₙ/[C]ᵢₙ ~ 1 to 1.3 - but more closely to 1.3). It is known that conversion of CH₄ to syngas (a mixture of primarily CO and H₂) depends on the [O]ᵢₙ/[C]ᵢₙ ratio. As the inlet concentration of oxygen is increased, amount of energy released increases leading to higher conversion efficiency. At the [O]ᵢₙ/[C]ᵢₙ ratios in the range of 1 to about 1.3 some soot formation occurs. The electric power input into the reactor is an important factor for estimating the unit costs of hydrogen production and found to be less than 0.09 kWh/m³ of H₂ produced which is a small fraction of the total heat value of the products obtained.

The process according to the present embodiment can utilize the in-situ generated soot to act as a catalyst promoting CH₄ pyrolysis and mitigate deactivation of traditional transition metal catalysts when used for the methane thermolysis. Furthermore, presence of soot particles facilitates capture and collection of the suboxide polymer formed via NTP reformation of CO. The process is simple and does not need a desulfurization unit. The process incorporates a straight forward carbon capture and storage technique. Others require cryogenic facility or consumables in the form of sorbents, etc.

The process according to the present embodiment can utilize non-thermal plasma reforming with air that is mostly nitrogen gas. It is known that nitrogen will readily go into a plasma state. Presence of nitrogen in the reactor promotes production of free radicals and ions with a lower input energy to the reactor.

In the process, the carbon monoxide generated by DBD-POX of natural gas is de-carbonized. Separation of hydrogen is carried out in a commercial PSA or a suitable metal hydride bed unit. The conversion of CO to a solid carbon suboxide polymer makes carbon sequestration simple. To capture carbon, a power supply is used that is capable of supplying power at densities on the electrode surface of at least 2 W/cm². Increasing the input power to the plasma reactor in effect increases the average electrode power density since the electrode area always remains constant. The initiation mechanism within the plasma is known to be either electron impact excitation of CO to CO^{∗}, electron impact dissociation of CO or some combination of the two. The initiation mechanism is always a function of the electron distribution function which depends on the power density. Thus, the initiation mechanism (electron impact excitation or electron impact dissociation of CO) may be controlled by varying the input power.

What is claimed is:

1. A method for producing hydrogen and a polymerized carbon suboxide, the method comprising:
(a) reacting natural gas by partial oxidation with air to produce a syngas which is a mixture of hydrogen (H₂), nitrogen (N₂) and carbon monoxide (CO);
(b) separating the syngas by chemical absorption into hydrogen and carbon monoxide; and
(c) converting the carbon monoxide in the presence of non-thermal plasma into carbon dioxide (CO₂) and a polymerized carbon suboxide residue.

2. The method of claim 1, further comprising:
(d) reacting the carbon dioxide of step (c) with hydrogen by reverse water-gas shift (RWGS) reaction to produce carbon monoxide (CO).

3. The method of claim 2, wherein that the carbon dioxide generated in step (c) is input to step (d) and the carbon monoxide generated in step (d) is input to step (c) is repeated at least once or more.

4. The method claim 1, wherein the partial oxidation occurs at a temperature in the range of 400° C. to 600° C.

5. The method claim 1, wherein the natural gas is reacted by partial oxidation with the air in the presence of at least one of a metal catalyst, in-situ generated carbon particles or a plasma catalyst.

6. An apparatus for producing hydrogen and a polymerized carbon suboxide, the apparatus comprising:
a first unit for reacting natural gas by partial oxidation with air to produce a syngas which is a mixture of hydrogen (H₂), nitrogen (N₂) and carbon monoxide (CO);
a second unit for separating the syngas by chemical absorption into hydrogen and carbon monoxide; and
a third unit for converting the carbon monoxide in the presence of non-thermal plasma into carbon dioxide (CO₂) and a polymerized carbon suboxide residue.

7. The apparatus of claim 6, wherein the apparatus further comprises:
a fourth unit for reacting the carbon dioxide with hydrogen by reverse water-gas shift (RWGS) reaction to produce carbon monoxide (CO).

8. The apparatus of claim 7, wherein that the carbon dioxide generated by the third unit is input to the fourth unit and the carbon monoxide generated by the fourth unit is input to the third unit is repeated at least once or more.

9. The apparatus of claim 6, wherein the partial oxidation occurs at a temperature in the range of 400° C. to 600° C.

10. The apparatus of claim 6, wherein the natural gas is reacted by partial oxidation with the air in the presence of at least one of a metal catalyst, in-situ generated carbon particles or a plasma catalyst.

11. An apparatus for producing hydrogen and carbon compound, the apparatus comprising:
a partial oxidation (POX) reactor for reacting natural gas by POX with air to produce a syngas which is a mixture of hydrogen (H₂), nitrogen (N₂) and carbon monoxide (CO);
a pressure swing absorption (PSA) unit for separating the syngas by PSA into hydrogen and carbon monoxide; and
a plasma reactor for converting the carbon monoxide in the presence of non-thermal plasma into carbon dioxide (CO₂) and a polymerized carbon suboxide residue.

12. The apparatus of claim 11, wherein a reverse water-gas shift (RWGS) reactor for reacting the carbon dioxide with hydrogen by RWGS reaction to produce carbon monoxide (CO).

13. The apparatus of claim 12, wherein that the carbon dioxide generated by the plasma reactor is input to the RWGS reactor and the carbon monoxide generated by the RWGS reactor is input to the plasma reactor is repeated at least once or more.

14. The apparatus of claim 11, wherein the POX in the POX reactor occurs at a temperature in the range of 400° C. to 600° C.

15. The apparatus claim 11, wherein the plasma reactor is disposed within the POX reactor.
